(19) United States
(12) Patent Application Publication
(10) Pub. No.: US 2010/0177416 A1
(43) Pub. Date: Jul. 15, 2010

(54) OPTICAL MEMBER AND OPTICAL FILTER FOR DISPLAY DEVICE HAVING THE SAME

(75) Inventors: Sung Nim Jo, ChungCheongNam-Do (KR); Ji Yoon Yeom, ChungCheongNam-Do (KR); Dong Keun Shin, ChungCheongNam-Do (KR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: SAMSUNG CORNING PRECISION GLASS CO., LTD., Gyeongsangbuk-do (KR)

(21) Appl. No.: 12/640,313

(22) Filed: Dec. 17, 2009

(30) Foreign Application Priority Data
Dec. 22, 2008 (KR) 10-2008-0131109

(51) Int. Cl. G02B 5/22

(52) U.S. Cl. 359/885

(57) ABSTRACT

An optical member of an optical filter provided for a display device includes a colorant which can selectively absorb light with a predetermined wavelength. The optical member satisfies a following expression:

0≦ΔE*=\sqrt{Δₐ*²+Δ_{b}*²}<5,

where ΔE* indicates the difference between reflected color and transmitted color under D65 standard light source. a* and b* correspond to achromatic colors satisfying following expressions: −2.0≦a*≦2.0, and −2.0≦b*≦2.0. An optical member of an optical filter provided for a display device includes a colorant which can selectively absorb light with a predetermined wavelength. The colorant may be a non-fluorescent colorant. The colorant includes a color adjusting colorant and a neon-cutting colorant. An optical filter for a display device includes this optical member.

### CROSS REFERENCE TO RELATED APPLICATION

The present application claims priority from Korean Patent Application Number 10-2008-0131109 filed on Dec. 22, 2008, the entire contents of which are incorporated herein for all purposes by this reference.

### BACKGROUND OF THE INVENTION

1. Field of the Invention

The present invention relates to a display device, and more particularly, to an optical filter for a display device and an optical member of the optical filter.

2. Description of Related Art

A display device includes a TV, a Personal Computer (PC) monitor, a portable display device, and the like. Such display devices are increasing in screen size and decreasing in thickness.

Consequently, Cathode Ray Tubes (CRTs), which have been representative display devices in the past, are now being replaced by Flat Panel Displays (FPDs) such as Liquid Crystal Displays (LCDs), Plasma Display Panel (PDP) devices, Field Emission Displays (FEDs), and Organic Light Emitting Displays (OLEDs).

PDP devices are gaining attention due to their excellent display performance in relation to luminance, contrast, afterimage, and viewing angle.

In a PDP device, when a direct or alternating voltage is charged to electrodes, ultraviolet (UV) radiation is generated in cells full of gas. The UV radiation in turn activates a fluorescent material, and thereby visible light is emitted. In this manner, the PDP device can display an image.

However, the PDP device radiates a large amount of Electro-Magnetic Interference (EMI) and Near-Infrared (NIR) radiation due to its characteristics. The EMI and NIR are harmful to the human body, and may cause precision devices such as mobile phones and remote controls to malfunction. In addition, due to the orange light emitted from the display module, the color purity of the PDP device is inferior to that of a Cathode Ray Tube (CRT).

Accordingly, the PDP device is provided with a PDP filter in order to overcome the foregoing problems. The PDP filter is provided in front of a display module.

The PDP filter includes a color compensation layer that contains a colorant which can selectively absorb a specific wavelength of light in order to improve color purity. In addition, the filter having an EMI shielding layer in the form of a conductive film may have a characteristic color, since the multiple metal oxide layers of the conductive film type EMI shielding layer have colors determined by the types of metal oxides and by their thicknesses. The characteristic color of the filter determines the quality of the exterior of the display device and has a great effect on the color of images.

With a conventional PDP filter, variation in color is great according to whether or not an image is being displayed (that is, whether a display device is ON or OFF), and variation in the color of the exterior of the display device is great according to an angle at which a viewer views the display device and the type and intensity of an external light source, which deteriorates the exterior quality of the display device.

The information disclosed in this Background of the Invention section is only for the enhancement of understanding of the background of the invention and should not be taken as an acknowledgment or any form of suggestion that this information forms a prior art that would already be known to a person skilled in the art.

### BRIEF SUMMARY OF THE INVENTION

The present invention has been devised to solve the foregoing problems with the related art. Various aspects of the present invention provide a display device in which variation in color according to whether or not an image is being displayed is not great, in which variation in the color of the exterior of the display device according to an angle at which a viewer views the display device and the type and intensity of an external light source is small, and in which the exterior quality of the display device is excellent.

In an aspect of the present invention, the optical member of an optical filter provided for a display device may include a colorant which can selectively absorb light with a predetermined wavelength. The optical filter preferably satisfies the following expression:

0≦ΔE*=\sqrt{Δₐ*²+Δ_{b}*²}<5,

where ΔE* indicates the difference between reflected color and transmitted color under the D65 standard light source.

In an exemplary embodiment of the invention, the colorant may be a non-fluorescent colorant.

In an exemplary embodiment of the invention, a* and b* may correspond to achromatic colors.

In another aspect of the present invention, the optical member of an optical filter for a display device may include a colorant which can selectively absorb light with a predetermined wavelength, in which the colorant is a non-fluorescent colorant.

In an exemplary embodiment of the invention, the colorant may include a color adjusting colorant and a neon-cut colorant.

In an exemplary embodiment of the invention, the optical member may include a polymer resin.

In an exemplary embodiment of the invention, the optical member may be a color compensation layer or a layer of adhesive.

In an exemplary embodiment of the invention, the optical member may be a colorant-containing resin layer of an external light-shielding layer, a colorant-containing resin layer of an electromagnetic interference shielding layer, a colorant-containing resin layer of an anti-reflection layer, a colorant-containing resin layer of a Near-Infrared (NIR) cutting layer, and a colorant-containing resin layer of an anti-glare layer.

In a further aspect of the present invention, the optical filter may include the above-described optical member.

In the display device according to the exemplary embodiments of the present invention as set forth above, variation in color according to whether or not an image is being displayed is not great, variation in the color of the exterior of the display device according to an angle at which a viewer views the display device and the type and intensity of an external light source is small, and the exterior quality of the display device is excellent. In addition, the display device can advantageously provide a clear image.

The methods and apparatuses of the present invention have other features and advantages which will be apparent from, or are set forth in more detail in, the accompanying drawings, which are incorporated herein, and the following Detailed Description of the Invention, which together serve to explain certain principles of the present invention.

### BRIEF DESCRIPTION OF THE DRAWINGS

FIG. 1 is an exploded perspective view schematically showing a display device according to a first embodiment of the invention;

FIG. 2 is a cross-sectional view schematically showing a filter according to a second exemplary embodiment of the invention;

FIG. 3 is a cross-sectional view schematically showing a filter according to a third exemplary embodiment of the invention;

FIG. 4 is a cross-sectional view schematically showing a filter according to a fourth exemplary embodiment of the invention; and

FIG. 5 is a graph showing transmission and reflection spectra of Experimental Examples 1 and 2 and Comparative Examples 1 and 2.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments that may be included within the spirit and scope of the invention as defined by the appended claims.

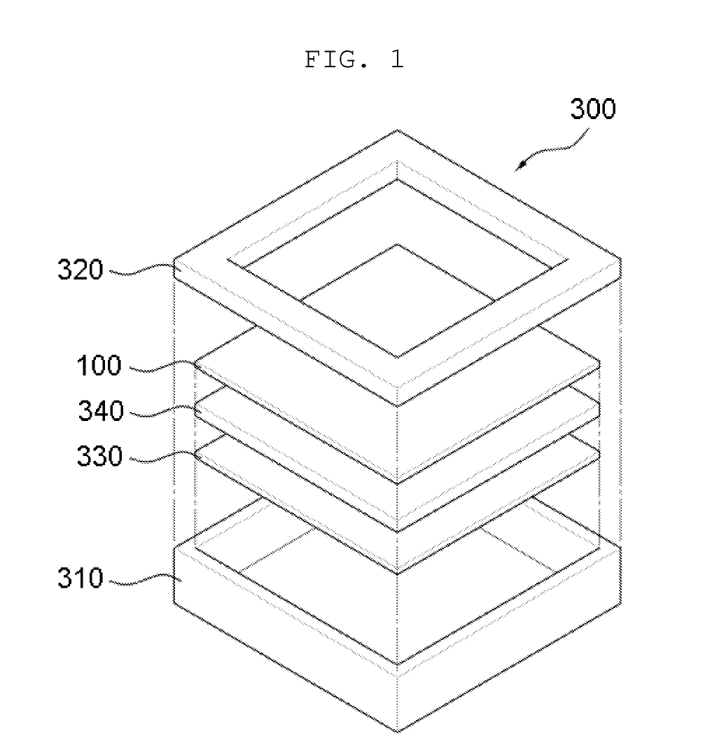

FIG. 1 is an exploded perspective view schematically showing a display device according to a first embodiment of the invention.

Referring to FIG. 1, a PDP device 300, a type of a display device according to an exemplary embodiment of the invention, generally includes a case 310, a cover 320, a drive circuit board 330, a display module 340, and a filter 100.

The cover 320 is disposed in front of the case 310 and covers the case 310. The drive circuit board 330 is provided inside the case 310. The display module 340 includes light emitting cells where gas discharge occurs, and displays images.

The filter 100 is mounted in front of the display module 340. An Electromagnetic Interference (EMI) shielding layer 130 of the filter 100, which will be described later, can be grounded to the case 310 via the cover 320. This can consequently make the filter shield, for example, viewers from EMI or the like generated from the display module 340.

An optical filter for a display device according to an exemplary embodiment of the invention can include one or more selected from a variety of functional optical layers such as a transparent substrate 110, an anti-reflection layer 120, the EMI-shielding layer 130, an external light-shielding layer 140, a color compensation layer 170, a Near-Infrared (IR) cutting layer 180, an anti-glare film 190, and the like.

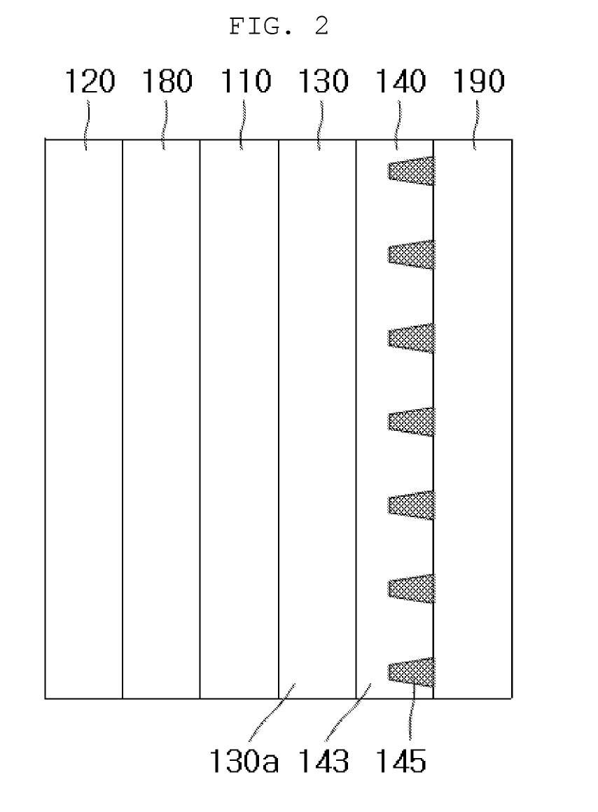

FIGS. 2 to 4 are cross-sectional views schematically showing the structures of filters according to second to fourth exemplary embodiments of the invention.

The filter shown in FIG. 2 includes an anti-reflection layer 120, an NIR cutting layer 180, a transparent substrate 110, an EMI shielding layer 130, an external light-shielding layer 140, and an anti-glare film 190, which are arranged sequentially from the front.

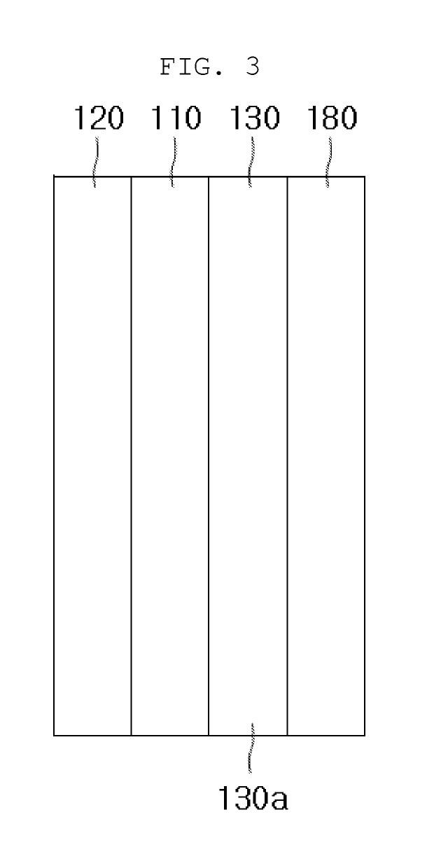

The filter shown in FIG. 3 includes an anti-reflection layer 120, a transparent substrate 110, an EMI shielding layer 130, and an NIR cutting layer 180, which are arranged sequentially from the front.

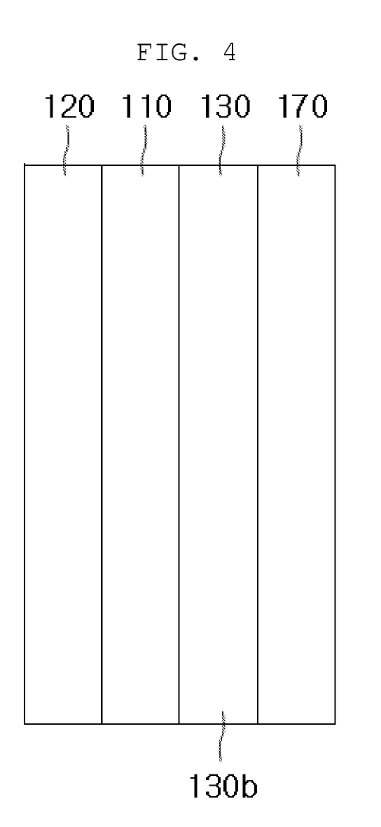

The filter shown in FIG. 4 sequentially includes an anti-reflection layer 120, a transparent substrate 110, an EMI shielding layer 130, and a color compensation layer 170.

However, FIGS. 2 to 4 are presented for the purposes of illustration, and obviously many modifications are possible.

For example, the types of layers that form a filter according to an exemplary embodiment of the invention can be selected variously according to the function of the filter to be realized. If necessary, some of the layers can be excluded from, or other layers can be added to the filters shown in FIGS. 2 to 4.

In addition, a filter according to an exemplary embodiment of the invention can have a variety of modifications with respect to the order in which the layers are stacked. For example, the stacking order of the layers of the filters shown in FIGS. 2 to 4 can be changed, if necessary.

In addition, a hybrid layer that performs the functions of two or more layers can be provided. For example, although the NIR cutting layer 180 is formed as a separate layer as shown in FIGS. 2 and 3, a hybrid layer, which is formed by adding an NIR absorbing material into a color compensation layer, can be provided.

The filter according to an exemplary embodiment of the invention includes an optical member containing a colorant which can selectively absorb light with a predetermined wavelength, and satisfying the following expression:

0≦ΔE*=\sqrt{Δₐ*²+Δ_{b}*²}<5

In the above expression, ΔE* indicates the difference between reflected color and transmitted color under the D65 standard light source.

Since the optical member essentially contains colorant, it may typically correspond to the color compensation layer, among the layers of the filters as described above. However, various other colorant containing layers of the filters can be used as the optical member. In addition, a resin layer containing a colorant mixed therein can also be used as the optical member. Such a resin layer may include, for example, a backing of the anti-reflection layer, a backing of the EMI shielding layer, a base or a backing of the external light-shielding layer, a base or a backing of the NIR cutting layer, a base or a backing of the anti-glare layer, and the like.

Hereinafter, respective layers will be separately described.

### Transparent Substrate 110

The transparent substrate 110 can be an inorganic compound molded substrate and an organic polymer molded substrate. Examples of the inorganic compound molded substrate can be made of heat-strengthened glass, quartz, and the like.

Examples of the organic polymer molded substrate can be made of Polyethylene Terephthalate (PET), acryl, Polycarbonate (PC), urethane acrylate, polyester, epoxy acrylate, brominate acrylate, Polyvinyl Chloride (PVC), and the like.

The transparent substrate 110 is required to be transparent in the range of visible light. Preferably, the transparent substrate 110 can transmit visible light at a transmittance of 80% or more.

### Color Compensation Layer 170

The color compensation layer 170 serves to adjust or correct color balance by reducing or adjusting the amount of red (R), green (G), and blue (B) light. The color compensation layer 170 can include a polymer resin in which a color adjusting colorant and a neon-cut colorant are mixed.

The color compensation layer 170 uses various types of colorants in order to increase the color reproduction range and improve the clearness of the displayed image. Such colorants may include dyes and pigments.

In general, visible red light, generated from plasma inside the display module, tends to discolor into orange light. Accordingly, the neon-cut colorant, which absorbs orange light (i.e., neon light), is used to reduce the transmittance of light having the corresponding wavelength.

The neon-cut colorant is not limited to specific kinds since it is only required to absorb 10 to 90% of light having a wavelength from 550 to 610 nm. Available examples of the neon-cut colorant include cyanines, polymethines, squarylium salts, phthalocyanines, naphthalocyanines, quinones, azaporphyrins, azos, azo-chelates, azuleniums, pyryliums, croconiums, indoaniline chelates, indonaphthol chelates, dithiol-metal complexes, pyrromethenes, azomethines, Xanthenes, and the like.

Available examples of the toning colorant include cyanines, anthraquinones, naphthoquinones, phthalocyanines, naphthalocyanines, di-immoniums, nickel (Ni) dithiols, azos, styryls, phthalocyanes, methines, porphyrins, azaporphyrins, and the like.

However, the colorants, which can be used in an exemplary embodiment of the invention, are not limited to the above illustrated examples. The types and concentrations of the colorants are not limited to specific types or values since they are determined by the absorption wavelengths and absorption coefficients of the colorants, as well as by the transmission characteristics required for use in displays.

A PDP filter is basically transparent. When no image is being displayed (that is, when a display device is Off), the reflected color of external light reflected from the filter is mainly shown to a viewer. In contrast, when an image is being displayed (that is, when a display device is On), the transmitted color becomes an important factor. When the difference between the transmitted and reflected colors is large, the variation in color according to whether or not an image is being displayed is large and the variation in the exterior color of the display device is large according to an angle at which a viewer views the display device and the type and intensity of an external light source. This also has an adverse effect on the quality of the display device.

Accordingly, this embodiment of the invention provides a color compensation layer, in which the difference between the reflected and transmitted colors is significantly reduced, and a filter including the color compensation layer. Due to the reduced difference between the reflected and transmitted colors, the color compensation layer and the filter including the color compensation layer can minimize the variation in color according to an angle at which a viewer views the display device and the type and intensity of external light sources to thereby provide a clear image.

In the difference between the reflected and transmitted colors, it has been found that the following two conditions act as major factors: The first condition is the characteristic color of the color compensation layer, and the second condition is the fluorescent characteristics of the color compensation layer.

The color compensation layer was formed by adding certain amounts of colorants into polymer resins. A simulation formula through which variation in the transmitted and reflected colors depending on the absorptivity of the colorants can be measured and estimated was devised, and then the absorption range that has a strong influence on the colors was precisely adjusted, whereby it was possible to design a spectrum of the color compensation layer that can minimize the difference between the transmitted and reflected colors. The result showed that as the color of the color compensation layer was near an achromatic color (−2.0≦a*≦2.0, and −2.0≦b*≦2.0), the difference between the transmitted and reflected colors was small.

In addition, it was also found that the fluorescent characteristics of the colorants increase the difference between the transmitted and reflected colors. When fluorescent colorants absorb UV rays from external light, they emit light having characteristic fluorescent wavelengths (e.g., from 380 to 780 nm, and especially, from 500 to 780 nm). Then, the reflected color by each colorant is mixed with the fluorescent color, which causes the difference between the transmitted and reflected colors to increase. Accordingly, it was possible to reduce the difference between the transmitted and reflected colors by using only the non-fluorescent colorants.

The color compensation layer for a PDP filter, in which the difference between the transmitted and reflected colors is expressed by the relationship: 0≦^{Δ}E*<5, and the PDP filter including the same color compensation layer make it possible to accurately and clearly present the color of a displayed image, since they vary little in color in response to changes in the external environment.

Here, ^{Δ}E* is expressed by the equation: ΔE*=\sqrt{Δₐ*²+Δ_{b}*²}. Unlike a typical color difference, as expressed by the equation: ΔE*=\sqrt{Δ_{L}*²+Δₐ*²+Δ_{b}*²}, the color difference in the present invention is calculated without considering ^{Δ}L*.

If ^{Δ}E* satisfies the above condition, the difference between the transmitted and reflected colors is reduced, thereby reducing variation in color according to whether the display device is turned On or Off, regardless of outside conditions.

Table 1 below shows the results of color variation obtained from color compensation layers in which the above-described two factors, i.e., the achromatism and fluorescent characteristics are varied.

TABLE 1

| | Color adjusting | | | |
|---|---|---|---|---|
| | colorant with | Ne-cut colorant | | |
| | Fluorescent | with Fluorescent | | |
| | characteristics | characteristics | ^{Δ}E | Remarks |
| EE* 1 | X | X | 4.4 | Color & transmittance |
| | | | | same as in CE 1 |
| EE 2 | X | X | 0.3 | Achromatic color |
| CE* 1 | ◯ | X | 6.1 | Color & transmittance |
| | | | | same as in EE 1 |
| CE 2 | ◯ | ◯ | 6.8 | — |

Note)
EE: Experimental Example, CE: Comparative Example

### Experimental Example 1

Azaporphyrin-based neon-cut colorant without fluorescent characteristics having a maximum absorption wavelength at 593 nm, and red and black color adjusting colorants without fluorescent characteristics were used. A color compensation film solution was prepared by calculating the content ratios of the colorants according to the intended color and transmittance and then adding the colorants into a PMMA resin. A color compensation film was produced by applying the prepared color compensation film solution, which is supposed to form a base, on a PET backing film at a thickness of about 8 μm, and then drying the applied solution at 100° C. for 1 minute.

### Experimental Example 2

Azaporphyrin-based neon-cut colorant without fluorescent characteristics having a maximum absorption wavelength at 593 nm, and red and black color adjusting colorant without fluorescent characteristics were used. A color compensation film solution was prepared by calculating the content ratios of the colorants according to the intended color, which is near an achromatic color (i.e., the values of a* and b* are near 0), and then adding the colorants into a PMMA resin. A color compensation film was produced by applying the prepared color compensation film solution on a PET film at a thickness of about 8 μm, and then drying the applied solution at 100° C. for 1 minute.

### Comparative Example 1

The content ratios of colorants which have the same intended color and transmittance as in Experimental Example 1 were used. The same color adjusting colorants were used, and a cyanine-based colorant with fluorescent characteristics having a maximum absorption wavelength at 593 nm was used as a neon-cut colorant. A color compensation film solution was prepared by adding the colorants into a PMMA resin. A color compensation film was produced by applying the prepared color compensation film solution on a PET film at a thickness of about 8 μm, and then drying the applied solution at 100° C. for 1 minute.

### Comparative Example 2

A cyanine-based neon-cut colorant with fluorescent characteristics having a maximum absorption wavelength at 593 nm, was used together with red, blue, and black color adjusting colorants with fluorescent characteristics. A color compensation film solution was prepared by calculating the content ratios of the colorants according to the intended color and transmittance and then adding the colorants into a PMMA resin. A color compensation film was produced by applying the prepared color compensation film solution on a PET film at a thickness of about 8 μm, and then drying the applied solution at 100° C. for 1 minute.

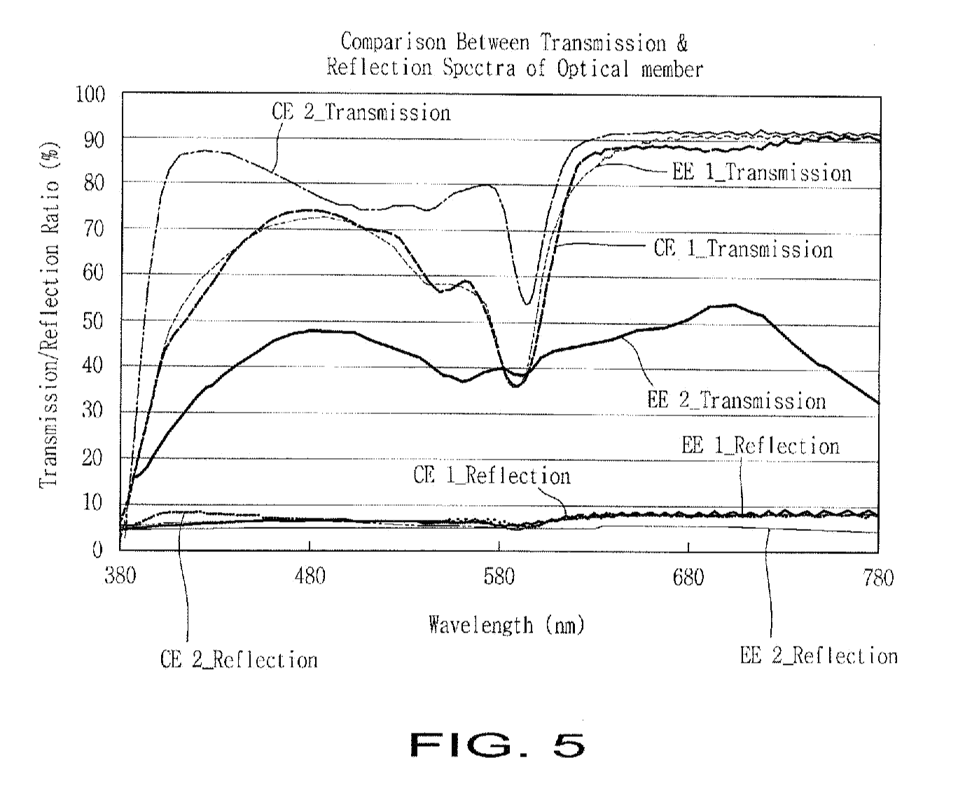

FIG. 5 is a graph showing transmission and reflection spectra of Experimental Examples 1 and 2 and Comparative Examples 1 and 2.

It can be understood from the figure that, in the case in which the same color and transmittance as in Comparative Example 1 was realized, the difference between the transmitted and reflected colors in Experimental Example 1 can be greatly reduced by using the neon-cut colorant without fluorescent characteristics.

In addition, referring to variation in the transmission and reflection spectra of Experimental Example 2, it can be understood that the variation between transmitted and reflected colors can be further reduced when the non-fluorescent colorant is used and the color of the filter is near an achromatic color.

### Anti-Reflection Layer 120

The anti-reflection layer 120 improves visibility by suppressing the reflection of external light.

An available example of the anti-reflection layer can be a single layer having, for example, a ¼ wavelength thickness, produced by forming a thin film using one selected from i) fluorinated transparent polymer resin, ii) magnesium fluoride, iii) silicon-based resin, iv) silicon oxide, and the like.

Alternatively, the anti-reflection layer can be formed by stacking two or more layers of thin films having different refractive indexes, in which each thin film can be made of an inorganic compound, such as metal oxides, fluorides, silicides, borides, carbides, nitrides, sulfides, or the like; or an organic compound, such as silicone resins, acryl resins, fluorine resins, or the like. For example, the anti-reflection layer may have a multi-layer structure in which a low-reflectivity oxide such as SiO₂ and a high-reflectivity oxide such as Nb₂O₅ are stacked repeatedly on one another.

### EMI Shielding Layer 130

Typically, the EMI shielding layer 130 is a conductive mesh type EMI shielding layer 130a or a conductive film type EMI shielding layer 130b.

FIGS. 2 and 3 show the conductive mesh type EMI shielding layer 130a. Typically, the conductive mesh type EMI shielding layer 130a has a conductive mesh pattern formed on a backing.

Available examples of the conductive mesh pattern generally include, but are not limited to, i) a metal mesh, ii) a synthetic resin mesh coated with metal, iii) a metal fiber mesh coated with metal, and the like.

The metal mesh pattern can be made of metals that have excellent electric conductivity and manufacturability. Available examples of the metals may include, but are not limited to, Cu, Cr, Ni, Ag, Mo, W, Al, and the like.

When compared to the conductive film type EMI shielding layer 130b, which will be described later, the conductive mesh type EMI shielding layer 130a does not have an NIR cutting function. Accordingly, a separate NIR cutting layer can be provided, and/or the backing of the conductive mesh type EMI shielding layer 130a may contain an NIR absorbing colorant.

FIG. 4 shows the conductive film type EMI shielding layer 130b. The conductive film type EMI shielding layer 130b can be a multi-layer structure of transparent thin films, in which metal thin films and metal oxide thin films are stacked alternately on one another. The metal oxide thin films can be made of, for example, Au, Ag, Cu, Pt, Pd, or the like. The metal oxide thin films can be made of, for example, Indium Tin Oxide (ITO), stannic oxide (SnO₂), zinc oxide (ZnO), Al-doped Zinc Oxide (AZO), or the like.

The conductive film type EMI shielding layer 130b has NIR cutting function. Thus, it is possible to ensure that both EMI and NIR are blocked using the conductive film type EMI layer 130b without using a separate NIR cutting layer. In this case, an NIR cutting layer can still of course be formed separately.

### External Light-Shielding Layer 140

The external light-shielding layer 140 includes a base 143 made of a transparent resin and an external light-shielding pattern 145 formed on one side of the base 143.

Although not shown, the external light-shielding layer 140 can include a backing. In this case, the base 143 is formed on the backing. Available examples of the backing may include, but are not limited to, Polyethylene Terephthalate (PET), Polycarbonate (PC), Polyvinyl Chloride (PVC), or the like. As the backing, a film that has a specific filtering function such as the anti-reflection layer 120, the color compensation layer 170, or the EMI shielding layer 130, can be used.

The base 143 is made of a transparent material that allows visible light to pass therethrough. Available materials of the base 143 may include, but are not limited to, PET, acryl, PC, urethane acrylate, polyester, epoxy acrylate, brominate acrylate, PVC, or the like.

An engraved pattern to be filled with a light-absorbing material or the like, is formed on the base by roll forming, thermal pressing, casting, injection molding, or the like.

The external light-shielding pattern can be formed using an UV curing resin, into which a light-absorbing material is mixed. The light-absorbing material can be, for example, black organic and/or inorganic materials which can absorb light. Typically, the light-absorbing material is carbon black. In addition, the external light-shielding pattern may contain a conductive material such as metal. When the external light-shielding pattern contains metal powder, it can contribute to the EMI-shielding function. Its electric resistance can be adjusted depending on the concentration of metal powder. Both the external light-shielding function and the EMI shielding function can be efficiently realized when black metal or black-surface-treated metal is used.

The external light-shielding pattern 145 typically has a stripe pattern when viewed from the front. However, the external light-shielding pattern 145 can have other shapes, such as a waved pattern, a mesh pattern, and the like.

When viewed from the side, the external light-shielding pattern may have a wedge-like shape, such as a trapezoidal shape or a triangular shape. However, the present invention is not limited thereto. For example, the external light-shielding pattern can have a variety of cross-sectional shapes other than the wedge-like shape, such as a rectangular shape, a U-like shape, and the like.

The bottom of the external light-shielding pattern 145 is typically directed toward the display module. However, the present invention is not limited thereto. For example, the bottom may face the viewers, or the wedge-like pattern can be formed on both the front and back sides of the base 143.

In addition, while the external light-shielding pattern 145 is typically an engraved pattern with respect to the base 143, it can also be an embossed pattern to protrude outward from the base 143.

The external light-shielding layer 140 prevents external environmental light from penetrating towards the display module by absorbing the light. The slope of the wedge of the external light-shielding layer 140 serves to totally reflect the display light emitted from the display module toward the viewers. This, as a result, makes it possible to realize high transmittance to visible light and high contrast.

### NIR Cutting Layer 180

The PDP device requires the use of an NIR cutting layer that can absorb NIR over a wide wavelength range, since it radiates strong NIR over the wide wavelength range.

The NIR cutting layer 180 functions to block NIR in a wavelength range from 850 to 950 nm, which would otherwise cause electronic devices, such as mobile phones and remote controls, to malfunction. Since the NIR cutting layer 180 blocks the NIR radiated by the PDP device, the function of the remote controls or the mobile phones is not adversely affected even if they are used close to the PDP device.

The NIR cutting layer 180 can contain an NIR absorbing material. As the NIR absorbing material, a material which can selectively absorb light with wavelengths in the NIR range is required.

The NIR absorbing material, available in an exemplary embodiment of the invention, can be one or more selected from, but are not limited to, i) mixed colorants of Ni complexes and di-immoniums, ii) compound colorants containing Cu ions and Zn ions, iii) cyanine-based colorants, iv) anthraquinone-based colorants, v) squarylium-based compounds, vi) azomethine-based compounds, vii) azo-based compounds, and viii) benzylidene-based compounds.

### Adhesive

Although not shown, a transparent adhesive or bonding agent can be used to join the respective layers together according to an exemplary embodiment of the invention. Specific examples may include, but are not limited to, i) acrylic adhesives, ii) silicone-based adhesives, iii) urethane-based adhesives, iv) polyvinyl butyral (PMB) adhesives, v) Ethylene-Vinyl Acetate (EVA) adhesives, vi) polyvinyl ether adhesives, vii) saturated amorphous polyester adhesives, viii) melamine resin adhesives, and the like.

However, some layers can be formed by direct coating, without using the adhesive. For example, the NIR cutting layer 180 shown in FIG. 2 can be formed directly on the backside of the anti-reflection layer 120. In addition, the conductive film type EMI shielding layer 130b shown in FIG. 4 is typically formed directly on the backside of the transparent substrate.

Although the adhesive is typically transparent, it can have a color if it contains a neon-cut colorant and/or a color adjusting colorant.

In addition, although the PDP optical filter and the PDP device have been illustrated for the sake of explanation, the present invention is not limited thereto. The optical filter of the invention is applicable to a variety of display devices including i) large display devices such as a PDP device, an Organic Light-Emitting Diode (OLED) device, a Liquid Crystal Display (LCD), and a Field Emission Display (FED); ii) small mobile display devices such as a Personal Digital Assistant (PDA), a display device for a small game machine, a display device for a mobile phone, and the like; iii) a flexible display device; and the like.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An optical member of an optical filter provided for a display device, comprising a colorant which can selectively absorb light with a predetermined wavelength, and satisfying a following expression:
0≦ΔE*=\sqrt{Δₐ*²+Δ_{b}*²}<5,
where ΔE* indicates the difference between reflected color and transmitted color under D65 standard light source.

2. The optical member according to claim 1, wherein the colorant is a non-fluorescent colorant.

3. The optical member according to claim 1, wherein a* and b* correspond to achromatic colors satisfying following expressions: −2.0≦a*≦2.0, and −2.0≦b*≦2.0.

4. The optical member according to claim 1, wherein the colorant includes a color adjusting colorant and a neon-cutting colorant.

5. The optical member according to claim 1, further comprising a polymer resin.

6. The optical member according to claim 1, wherein the optical member is a color compensation layer.

7. The optical member according to claim 1, wherein the optical member is a layer of adhesive.

8. The optical member according to claim 1, wherein the optical member is a colorant-containing resin layer of an external light-shielding layer, a colorant-containing resin layer of an electromagnetic interference shielding layer, a colorant-containing resin layer of an anti-reflection layer, a colorant-containing resin layer of a near-infrared cutting layer, or a colorant-containing resin layer of an anti-glare layer.

9. An optical filter for a display device, comprising an optical member, the optical member including a colorant which can selectively absorb light with a predetermined wavelength, and satisfying a following expression:
0≦ΔE*=\sqrt{Δₐ*²+Δ_{b}*²}<5
where ΔE* indicates the difference between reflected color and transmitted color under D65 standard light source.

10. The optical filter according to claim 9, wherein the colorant is a non-fluorescent colorant.

11. The optical filter according to claim 9, wherein a* and b* correspond to achromatic colors satisfying following expressions: −2.0≦a*≦2.0, and −2.0≦b*≦2.0.
